(19) United States
(12) Patent Application Publication
(10) Pub. No.: US 2003/0070024 A1
(43) Pub. Date: Apr. 10, 2003

(54) Six-in-one connector

(76) Inventors: Steel Su, Taipei (TW); Toon Jeow Foo, Singapore (SG)

Correspondence Address: ROSENBERG, KLEIN & LEE, 3458 ELLICOTT CENTER DRIVE-SUITE 101, ELLICOTT CITY, MD, 21043, US

(21) Appl. No.: 09/969,596

(22) Filed: Oct. 4, 2001

(51) Int. Cl. G06F 13/00

(52) U.S. Cl. 710/300

(57) ABSTRACT

A six-in-one connector used for CD-ROM drives and installed on the back end plane of the CD-ROM drive unit which comprises a drive unit having an internal memory card read/write device. The front panel of the CD-ROM drive has a related button/indicator, an adjusting button, a CD tray and at least a memory card slot (or memory card convert socket slot) corresponding to the internal memory card read/write device of the drive unit. The six-in-one connector has a Digital Audio Port, a Line Out, a Master/slave Port, and IDE/SCSI Port, a Power and an additional Memory Data Port used as a signal output/input port of the internal memory card read/write device in the drive unit.

### BACKGROUND OF THE INVENTION

The present invention relates to a six-in-one connector, especially to a connector installed on a dual CD-ROM drive with additional data accessing devices and used for the connection of six signal/power plugs.

Conventional CD-ROM drives usually have only five-in-one connector for the connection of required signal and power plugs and perform data accessing and transmission actions only for a single media, i.e. CD. This design is insufficient for computer systems that need multiplex operations. Though additional data accessing devices can be installed to gain additional functions, the costs for hardware may increase and the location of the installation or the space for the installation may not be suitable for the additional devices.

### SUMMARY OF THE INVENTION

The primary objective of the present invention is to provide a six-in-one connector installed on the back end plane of a CD-ROM drive unit for the connection of signal and power terminals. The CD-ROM drive unit has an internal memory card read/write device and is integrated into a single drive unit. The panel of the CD-ROM drive has a related button/indicator, an adjusting button, a CD tray and at least a memory card slot (or memory card convert socket slot) that is corresponding to the memory card read/write device. In addition to the conventional Digital Audio Port, Line Out, Master/slave Port, IDE/SCSI Port and Power, an additional Memory Data Port is included in the six-in-one connector used as the signal output/input port of the internal memory card read/write device in the drive unit to improve the data accessing function of the CD-ROM drive significantly.

### BRIEF DESCRIPTION OF THE DRAWINGS

FIG. 1 is a perspective view of the dual CD-ROM drive having the six-in-one connector of the invention;

FIG. 2 is a perspective view of the six-in-one connector installed on the back end plane of the CD-ROM drive; and

FIG. 3 is a perspective view of the six-in-one connector.

### DETAILED DESCRIPTION OF THE PREFERRED EMBODIMENT

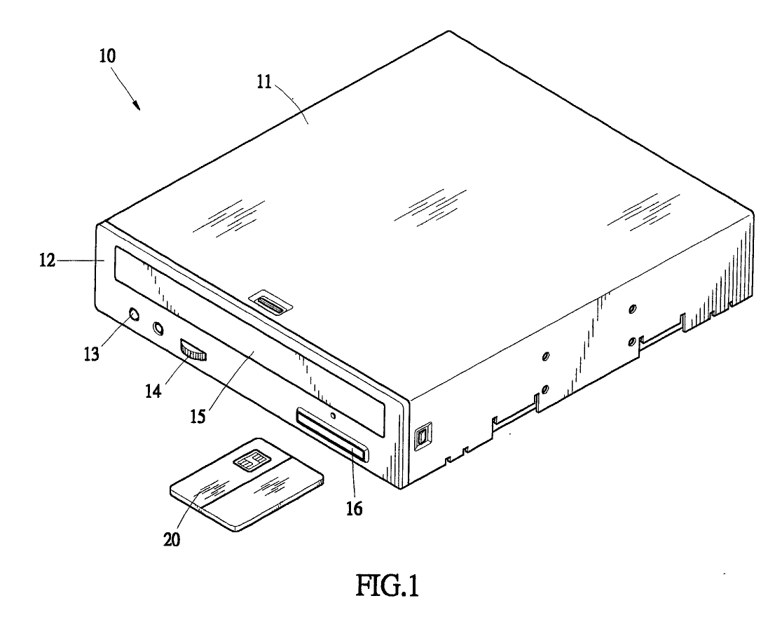

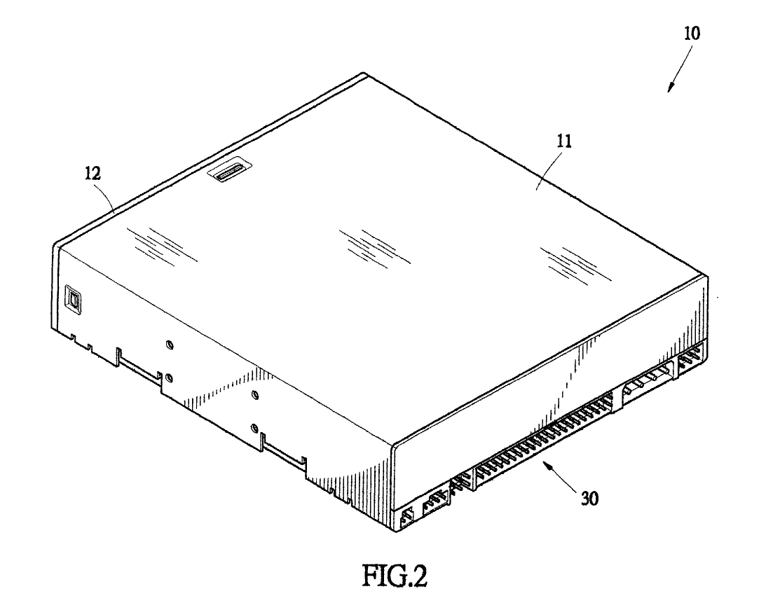

As shown in FIGS. 1 and 2, the six-in-one connector 30 of the invention is installed on the back end plane of the CD-ROM drive 10 which comprises a drive unit 11 and a front panel 12.

The drive unit 11 of the CD-ROM drive 10 has an internal memory card read/write device (not shown in the figures). The panel 12 has a related button/indicator 13, an adjusting button 14, a CD tray 15 and a memory card slot 16 (or memory card convert socket slot). The memory card slot 16 is corresponding to the internal memory card read/write device of the drive unit 11 and used for the insertion of an additional memory card 20 to provide an additional data accessing function for the CD-ROM drive.

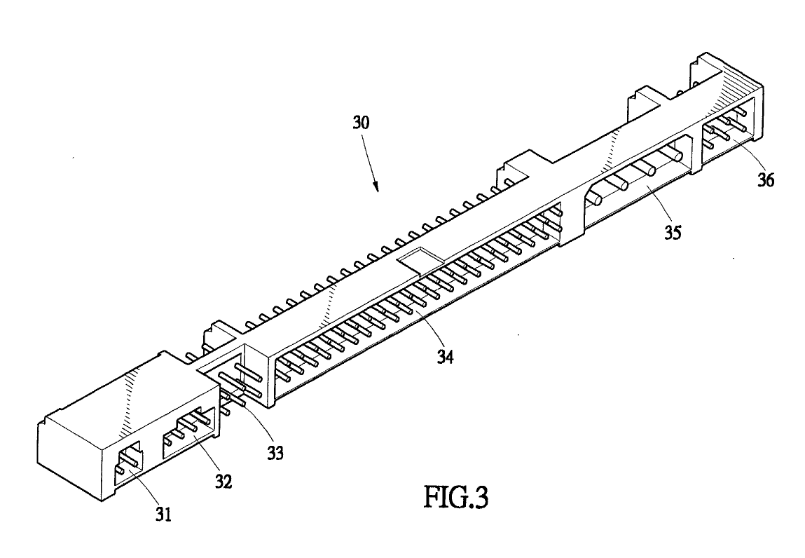

As shown in FIGS. 2 and 3, the six-in-one connector 30 is installed on the back end plane of the drive unit 11 for the connection of the signal/power terminals. The six-in-one connector 30 has a Digital Audio Port 31, a Line Out 32, a Master/slave Port 33, and IDE/SCSI Port 34, a Power 45 and an additional Memory Data Port 36. The Memory Data Port 36 is used as a signal output/input port of the internal memory card read/write device in the drive unit 11 to improve the data accessing function of the CD-ROM drive 10 significantly.

In addition to reading from and writing into CD via CD-ROM drive as other traditional CD-ROM drives, the six-in-one connector can access and transmit data via the additional data accessing device in the drive unit 11 and the additional Memory Data Port 36. It is especially useful to complete the tasks in the multiplex operation environment commonly used nowadays.

The additional Memory Data Port of the six-in-one connector is installed in the existing space on the back end plane of the CD-ROM drive, without the need to change the housing and its appearance.

The present invention can improve the data accessing functionality of the CD-ROM drive by connecting a second media to the six-in-one connector on the same drive unit. The invention is so described in detail that any person who learns this technique can bring it into practice. It should be understood that the above-mentioned embodiment is for description only and all equitant changes of the structure and modifications within the scope of the present invention shall be regarded as part of the present invention.

What is claimed is:

1. A six-in-one connector installed on the back end plane of a CD-ROM drive which comprises a drive unit and a front panel, the drive unit of the CD-ROM drive having an internal memory card read/write device, the front panel having a related button/indicator, an adjusting button, a CD tray and a memory card slot, wherein:
the six-in-one connector installed on the back end plane of the drive unit for the connection of the signal/power terminals; the six-in-one connector including a Digital Audio Port, a Line Out, a Master/slave Port, and IDE/SCSI Port, a Power and an additional Memory Data Port used as a signal output/input port of the internal memory card read/write device in the drive unit to improve the data accessing function of the CD-ROM drive significantly.
